(19) United States
(12) Patent Application Publication
(10) Pub. No.: US 2025/0386398 A1
(43) Pub. Date: Dec. 18, 2025

(54) TECHNIQUES FOR IMPROVED EMERGENCY TEST COMMUNICATION ROUTING

(71) Applicant: T-Mobile USA, Inc., Bellevue, WA (US)

(72) Inventor: Tommy Yau, Sammamish, WA (US)

(21) Appl. No.: 18/747,279

(22) Filed: Jun. 18, 2024

(51) Int. Cl. H04W 76/50; H04L 65/1016; H04W 24/08; H04W 64/00

(52) U.S. Cl. CPC H04W 76/50; H04L 65/1016; H04W 24/08; H04W 64/00

(57) ABSTRACT

Techniques are described herein for providing improved routing of test emergency communications. Such techniques may comprise receiving, from a user equipment (UE), an emergency communication and identifying, based on information about the UE, a public service access point (PSAP) device to which the emergency communication should be routed. The techniques may further comprise determining that the emergency communication is a test communication, updating the emergency communication to include an indication that the emergency communication is a test communication, and forwarding the updated emergency communication to the PSAP device.

### BACKGROUND

In telecommunication, an Internet Protocol Multimedia Subsystem (IMS) is an architectural framework defined by the 3rd Generation Partnership Project (3GPP) for delivering Internet Protocol (IP) multimedia to user equipment (UE) of the IMS network. An IMS core network (sometimes referred to as the “IMS core,” the “Core Network (CN),” or the “IM CN Subsystem”) permits wireless and wireline devices to access IP multimedia, messaging, and voice applications and services. IMS allows for peer-to-peer communications, as well as client-to-server communications over an IP-based network.

During a registration procedure with the IMS core network, the UE is assigned a serving call session control function (S-CSCF) node and an application server (AS). These assigned nodes are tasked with serving the UE during a subsequent communication session, and all signaling originating from, and terminating at, the UE during the communication session is to be routed through the assigned nodes of the IMS core.

The enhanced 911 (e911) service was developed in response to the increasingly mobile nature of modern communications. e911 enables a user to dial 911 and be connected to the appropriate emergency services regardless of their location.

In order to ensure that e911 services are carried out in an optimal manner, operators of a network must often perform testing of new and/or existing functionality. This often involves sending test communications to a Public Service Access Point (PSAP) to be processed in a manner similar to actual emergency communications. However, these test communications may be routed to operators that either don't understand how the test communications should be handled or are otherwise occupied with handling real emergency communications.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 depicts a diagram illustrating an overview of a network architecture 100 having a number of components that may be implemented in accordance with some embodiments.

FIG. 2 depicts a component diagram of an example system to be implemented via a network in order to enable implementation of automated emergency test routing in accordance with some embodiments.

FIG. 3 depicts a block diagram illustrating interactions between various components that may be implemented in a PSAP system 300 in accordance with at least some embodiments.

FIG. 4 depicts a flow chart illustrating an exemplary process for labeling and routing emergency communications in accordance with embodiments.

FIG. 5 depicts a flow diagram illustrating an exemplary process for labeling and routing emergency communications directed to a testing process in accordance with at least some embodiments.

FIG. 6 depicts a flow diagram illustrating an exemplary process for routing emergency communications within a PSAP in accordance with at least some embodiments.

### DETAILED DESCRIPTION

This disclosure describes methods and systems for providing improved routing of emergency communications for testing purposes. In embodiments, an identifier for test communications can be added to a list of identifiers associated with emergency services. Upon receiving a communication that is associated with that identifier, a network node (e.g., an E-CSCF node) may be configured to apply a label to that message identifying that it is a test communication. For example, the network node may update a data value in a data field of the communication to include such an indication.

The network node may then route the labeled communication to a computing device operating within a PSAP system (e.g., a PSAP device). That device may then determine that the communication is a test communication based on the applied label. The communication is then routed by the computing device to a test system rather than to an operator station as for a typical communication.

Embodiments of the disclosure provide for a number of advantages over conventional systems. For example, the implemented system allows for test communications to be processed by a PSAP system without operator interaction. More particularly, the disclosure allows for such test communications to be routed to a test system directly without requiring operator interaction. This further allows operators to focus on real emergency communications and may also improve the accuracy of test results received in relation to the test communications.

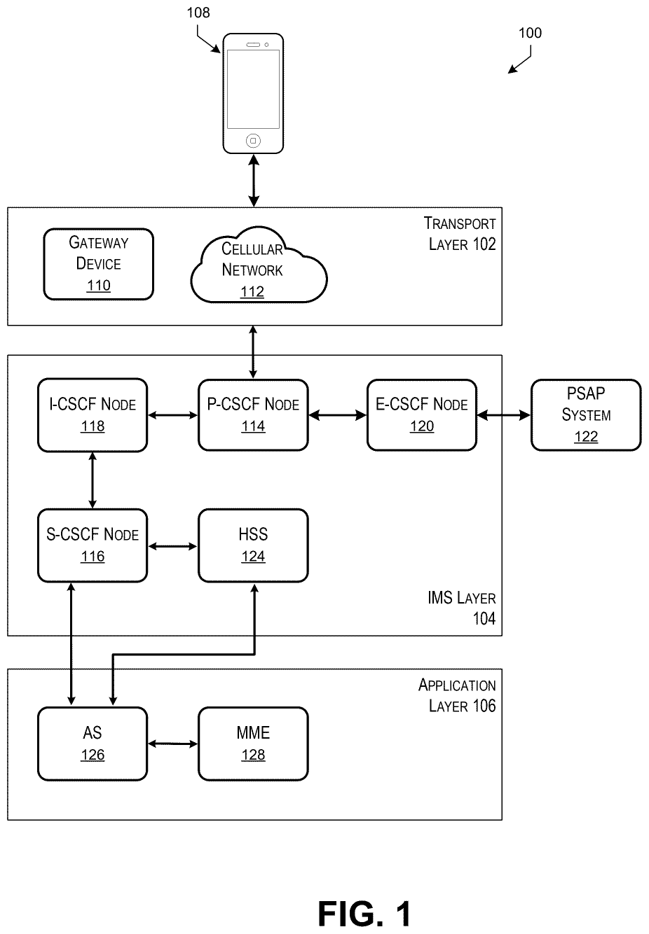

FIG. 1 depicts a diagram illustrating an overview of a network architecture 100 having a number of components that may be implemented in accordance with some embodiments. In embodiments, the network architecture 100 may be made up of multiple layers, each of which includes a different set of nodes. For example, the network architecture 100 may be representative of an IMS network that includes at least a transport layer 102, an IMS layer 104, and an application layer 106.

A transport layer 102 is responsible for connecting different access technologies users' devices to the IMS domain and for connection of the domain to other packet-switched and circuit-switched networks. A transport layer 102 may include any node (e.g., equipment) configured to provide access (e.g., ingress/egress) to the network architecture 100 for a number of user equipment (UE) 108. For example, a transport layer 102 may include a gateway device, such as a gateway device 110 that provides fixed access (e.g., digital subscriber line (DSL), cable modems, Ethernet, FTTx), mobile access (e.g., 5G NR, LTE, W-CDMA, CDMA2000, GSM, GPRS), and/or wireless access (e.g., WLAN, WiMAX). In some cases, the transport layer 102 may include a cellular network 112 that may include second generation (2G) 702, third generation (3G) 704, fourth generation (4G) long-term evolution (LTE) 706, and/or fifth generation (5G) components.

An IMS layer 104 (also referred to as a control layer) may include any node configured to process SIP signaling packets within the network architecture 100. Such nodes may generally be referred to as Call Session Control Function (CSCF) nodes. CSCF nodes can be further distinguished based on their respective roles. For example, CSCF nodes may include a Proxy CSCF (P-CSCF) node 114, a Service CSCF (S-CSCF) node 116, and an Interrogating CSCF (I-CSCF) node 118. The P-CSCF node 114 may be further in communication with an emergency CSCF (E-CSCF) node 120 configured to route messages to Public Service Access Point (PSAP) system 122.

It is to be appreciated that the IMS network may include additional nodes that are not described herein such as nodes including, without limitation, a security gateway (SEG), a session border controller (SBC), and so on. In some cases, the IMS layer 104 may further include a Home Subscriber Server (HSS) 124. However, it should be noted that while the HSS 124 is depicted in the IMS layer 104 in FIG. 1, the HSS 124 may instead be implemented within an application layer 106 in some embodiments of a network architecture 100 or even outside of the IMS network.

A P-CSCF node 114 is a proxy device that acts as a first point of contact for UE 108 within the IMS Network. Each UE is assigned to a respective P-CSCF when it is registered with the IMS Network. A P-CSCF node 114 can receive, via a communications interface, a Session Initiation Protocol (SIP) request from the UE 108 to be forwarded to a S-CSCF node 116.

A S-CSCF node 116 is the central nodes of the signaling plane and sits on the path of all signaling messages to/from a UE 108 that is assigned to it. There can be multiple S-CSCF nodes in the network for load distribution and high availability reasons. A S-CSCF node 116 is typically assigned to a user (or UE) by a Home Subscriber Server (HSS) 124, when it's queried by the I-CSCF node 118.

A S-CSCF node 116 may represent one of multiple available S-CSCF nodes that is chosen (or otherwise selected) for assignment to the UE 108. S-CSCF nodes, such as the S-CSCF node 116, are sometimes referred to as “Registrars,” and the process of allocating Registrars among users who are registering for IMS-based services is sometimes referred to as finding a “home CSCF” node for the UE 108.

A I-CSCF node 118 is a SIP function node that acts as a forwarding point for external devices. The I-CSCF node 118 queries the HSS to determine S-CSCF node/UE mapping and forwards SIP requests between the P-CSCF node 114 and the respective S-CSCF node 116.

The HSS 124 is typically a master user database that supports the IMS network nodes that handle the calls/sessions. It contains user profiles, performs authentication and authorization of the user, and can provide information about the physical location of a user. A user profile may be associated with each UE 108 and may contain information about the current user. Such information may be downloaded by the S-CSCF node 116 assigned to the user when the user is registered on the network. The S-CSCF node 116 may typically receive that information in a User-data Attribute Value Pair (AVP) format.

An application layer 106 (also referred to as a service layer) may include one or more nodes capable of providing IMS-related services to the UE 108. In embodiments, the application layer 106 may include at least a number of Application Servers (AS) 126, as well as a Mobility Management Entity (MME) 128. As noted above, the application layer 106 may further include a HSS 124 in some embodiments.

An AS 126 hosts and executes services, and interface with the S-CSCF node 116 using messages formatted using a SIP protocol. Depending on the actual service, the AS 126 can operate in SIP proxy mode, SIP UA (user agent) mode or SIP B2BUA mode. An AS 126 can be located in the network architecture 100 or in an external third-party network. If located in the network architecture 100, it may be able to query, or otherwise interact with the HSS 124 (e.g., using Diameter interfaces). In embodiments, the AS 126 manages an application that provides communication between two or more UEs (e.g., UE 108 and at least one other UE). For example, the AS 126 may manage an application that provides Voice over IP (VOIP) communications between UE devices.

In embodiments, an AS 126 may be configured to make service initiation decisions based on information about a UE 108 to which a communication is being directed. For example, the AS 126 may receive a communication directed to initiation of a service at a UE 108. By way of illustration, another UE may initiate a Voice over Internet Protocol (VOIP) call to a UE 108. In this illustration, the AS 126 receives a request to initiate the VOIP call as well as an identifier for the UE 108. Upon receiving such a communication, the AS 126 may retrieve information about the UE 108 from a second entity that maintains updated information about a status of the UE 108. Such a communication may be routed through the HSS 124. For example, the AS 126 may provide a request to the HSS 124 (which maintains information about services associated with the account for that UE 108) and the HSS 124 further communicates with an MME 128 to retrieve such information. The AS 126 may then make a determination about whether the service should or should not be initiated based on the received information and absent additional communications within the network architecture 100.

The network architecture 100 may include at least one node that provides a Media Gateway Control Function (MGCF) node that enables interaction between the IMS network and at least one other network, such as a telephonic network (Public Switched Telephone Network (PSTN)). In embodiments, a MGCF node may be configured to translate between SIP messaging and other formats in order to facilitate inter-network messaging.

The UE 108 may include any electronic device capable of interacting with the network architecture 100. In some non-limiting examples, the UE 108 may be a variety of devices including, for example: a mobile phone, a personal data assistant (PDA), or a mobile computer (e.g., a laptop, notebook, notepad, tablet, etc.) having mobile wireless data communication capability. The UE 108 may be configured to register for, and thereafter access and utilize, one or more IMS-based services via the network architecture 100. To this end, the UE 108 may be configured to transmit, via a radio access network (RAN), messages to the IMS network. For example, the UE 108 may transmit messages to the IMS network as part of an IMS registration procedure where the UE 108 is requesting to register for an IMS-based service.

The UE 108 may, upon registration with the network architecture 100, be assigned to a P-CSCF node 114 as well as a S-CSCF node 116. Communications from the UE 108 to an AS 126 of the network architecture 100 are then routed from the UE 108 to the P-CSCF node 114 and then to the S-CSCF node 116 (through forwarding by the I-CSCF node 118) and subsequently to the AS 126. Conversely, communications from an AS 126 of the network architecture 100 to the UE 108 are routed from the AS 126 to the S-CSCF node 116 and then to the P-CSCF node 114 and subsequently to the UE 108.

During operation, a UE 108 may attempt to initiate a connection with an IMS network via a respective transport layer 102. The UE 108 may make such a connection to the IMS layer 104 over a cellular network (e.g., cellular network 112) or a suitable gateway device (e.g., a wireless router). The communication is established between the UE 108 and a P-CSCF node 114 that is assigned to that UE 108.

When the communication is received at a P-CSCF node 114 from the UE 108, a determination may be made as to whether or not that communication is an emergency communication. In embodiments, such a determination may be made based on an identifier that is included in the communication. For example, the determination may be made based on a Mobile Station Integrated Services Digital Network (MSISDN) identifier indicated within the communication. In such cases, communications directed toward the MSISDN may be classified as a SOS invite (emergency communication).

Upon making a determination that the communication is not an emergency communication, the P-CSCF node 114 is configured to route that communication to the S-CSCF node 116. Alternatively, upon making a determination that the communication is an emergency communication, the P-CSCF node 114 routes that communication to the E-CSCF node 120 to be routed to an appropriate emergency service.

In embodiments, upon receiving an emergency communication, the E-CSCF node 120 may make a determination as to whether the communication relates to an actual emergency or to an emergency system testing communication. Such a determination may be made based on the identifier (e.g., MSISDN) included in the communication. In such cases, the E-CSCF node 120 may consult an Extended Emergency Number List (EENL) to make such a determination. For example, a communication directed toward MSISDN “765” may be determined to be an emergency system testing communication. Upon determining that the communication relates to emergency system testing, the E-CSCF node 120 may update a data field (e.g., a service field) of the communication to reflect that it is an emergency system testing communication. The E-CSCF node 120 may then forward the communication to the PSAP system 122 to be processed.

Upon receiving the communication, the PSAP system 122 may be configured to automatically route any communications which have been identified as being emergency system testing communications to an automated testing system. In contrast, the PSAP system 122 may be configured to route any communications which have not been identified as being emergency system testing communications to an operator in order to be dispatched to an appropriate emergency services agency.

In accordance with various embodiments described herein, the terms “user equipment (UE),” “wireless communication device.” “wireless device,” “communication device,” “mobile device,” and “client device,” may be used interchangeably herein to describe any UE (e.g., the UE 108) that is capable of transmitting/receiving data over the IMS network, perhaps in combination with other networks. A users can utilize the UE 108 to communicate with other users and associated UEs via the IMS network. For example, a service provider may offer multimedia telephony services that allow a subscribed user to call or message other users via the IMS network using his/her UE 108. A user can also utilize the UE 108 to receive, provide, or otherwise interact with various different IMS-based services by accessing the IMS network. In this manner, an operator of the IMS network may offer any type of IMS-based service, such as, telephony services, emergency services (e.g., E911), gaming services, instant messaging services, presence services, video conferencing services, social networking and sharing services, location-based services, push-to-talk services, and so on.

Furthermore, the IMS network that includes the IMS nodes 114-120 may enable peer-to-peer, client-to-client, and/or client-to-server, communications over wired and/or wireless networks using any suitable wireless communications/data technology, protocol, or standard, such as Global System for Mobile Communications (GSM), Time Division Multiple Access (TDMA), Universal Mobile Telecommunications System (UMTS), Evolution-Data Optimized (EVDO), Long Term Evolution (LTE), Advanced LTE (LTE+), Generic Access Network (GAN), Unlicensed Mobile Access (UMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), High Speed Packet Access (HSPA), evolved HSPA (HSPA+), Voice over IP (VOIP), Voice over LTE (VOLTE), IEEE 802.1x protocols, WiMAX, Wi-Fi, Data Over Cable Service Interface Specification (DOCSIS), digital subscriber line (DSL), and/or any future IP-based network technology or evolution of an existing IP-based network technology.

The network architecture 100 of FIG. 1 may be maintained and/or operated by one or more service providers, such as one or more wireless carriers (“operators”), that provide mobile IMS-based services to users (sometimes called “subscribers”) who are associated with UEs, such as the UE 108. The IMS network may represent any type of SIP-based network that is configured to handle/process SIP signaling packets or messages. SIP is a signaling protocol that can be used to establish, modify, and terminate multimedia sessions (e.g., a multimedia telephony call) over packet networks, and to authenticate access to IMS-based services. Individual nodes of the IMS nodes 114-120 of FIG. 1 can also be configured to transmit data to/from the HSS 124 using Diameter protocol over a Diameter interface. In one example, such a Diameter interface may be a Diameter (Cx) when the interface is accessed via a I/S-CSCF node. In another example, such a Diameter interface may be a Diameter (Sh) when the interface is accessed via an application server. Diameter protocol is defined by the Internet Engineering Task Force (IETF) in RFC 6733.

For clarity, a certain number of components are shown in FIG. 1. It is understood, however, that embodiments of the disclosure may include more than one of each component. In addition, some embodiments of the disclosure may include fewer than or greater than all of the components shown in FIG. 1. In addition, the components in FIG. 1 may communicate via any suitable communication medium (including the Internet), using any suitable communication protocol.

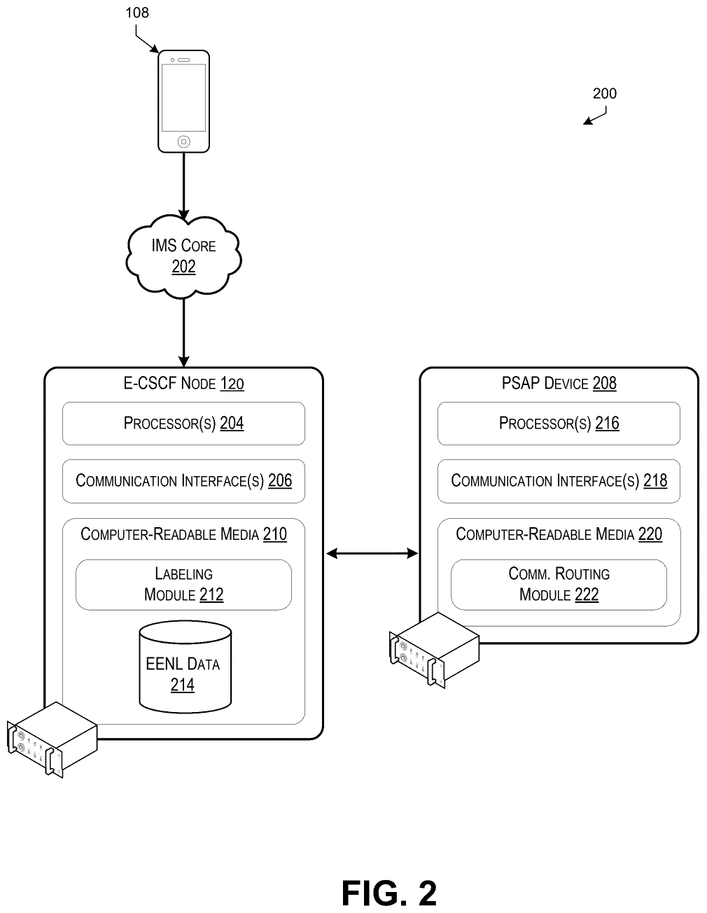

FIG. 2 depicts a component diagram of an example system to be implemented via a network (e.g., an IMS network) in order to enable implementation of automated emergency test routing in accordance with some embodiments. As depicted in FIG. 2, an E-CSCF node 120 may be in wireless communication over an IMS core 202 of an IMS network with a UE 108 that is operated by a user. As noted elsewhere, the connection between the UE 108 and the E-CSCF node 120 operating over the network may be facilitated by a cellular network (e.g., cellular network 112).

The UE 108 may be an example of a UE 108 as described in relation to FIG. 1 above. As noted elsewhere, a UE 108 may include any suitable electronic device configured to interact with a network.

In embodiments, an exemplary E-CSCF node 120 may be an example of an E-CSCF node 120 as described in relation to FIG. 1 above. The E-CSCF node 120 may be implemented within an IMS network. It should be noted that the E-CSCF node 120 (or any other described computing component) may include a single computing device (e.g., a server device) or a combination of computing devices. In some cases, the E-CSCF node 120 may be implemented as a virtual device/system (e.g., via virtual machines implemented within a cloud computing environment).

As illustrated, the E-CSCF node 120 may include one or more hardware processors 204 configured to execute one or more stored instructions. Such processor(s) 204 may comprise one or more processing cores. Further, the E-CSCF node 120 may include one or more communication interfaces 206 configured to provide communications between the E-CSCF node 120 and other devices, such as the UE 108, a PSAP device 208 or any other suitable electronic device.

The E-CSCF node 120 may also include computer-readable media 210 that stores various executable components (e.g., software-based components, firmware-based components, etc.). The computer-readable media 210 may store components to implement functionality described herein. While not illustrated, the computer-readable media 210 may store one or more operating systems utilized to control the operation of the one or more devices that comprise the E-CSCF node 120. According to one instance, the operating system comprises the LINUX operating system. According to another instance, the operating system(s) comprise the WINDOWS® SERVER operating system from MICROSOFT Corporation of Redmond, Washington. According to further embodiments, the operating system(s) can comprise the UNIX operating system or one of its variants. It should be appreciated that other operating systems can also be utilized.

The computer-readable media 210 may include portions, or components, that configure the E-CSCF node 120 to perform various operations described herein. For example, the computer-readable media 210 may include some combination of components configured to implement the described techniques. Particularly, the E-CSCF node 120 may include a component configured to label emergency communications determined to be directed to testing (e.g., labeling module 212). Additionally, the computer-readable media 210 may further maintain one or more databases or other data storage structures that maintain mapping between identifiers and statuses (e.g., EENL data 214).

The labeling module 212 may be configured to, when executed by the processors 204, cause the E-CSCF node 120 to apply a label to certain emergency communications. More particularly, the labeling module 212 may be configured to determine whether an emergency communication received at the E-CSCF node 120 is to be directed to an automated testing process based on whether that emergency communication satisfies certain conditions. For example, an emergency communication may be determined to be directed toward an automated testing process based on an identifier included in the emergency communication corresponding to a predetermined identifier listed in EENL data 214. For example, emergency communications directed toward a particular identifier (or a set of identifiers) may be determined to be directed toward an automated testing process.

Upon making a determination that an emergency communication is directed toward an automated testing process, the labeling module 212 may be configured to edit the communication to indicate such. For example, the labeling module 212 may be configured to update a data field value for the emergency communication to relay that it is to be directed to the automated testing process. In this example, the labeling module 212 may be configured to update a data value for a service field to “Automated Test.” In embodiments in which the emergency communication is determined to be directed toward an automated testing process, the labeling module 212 may be configured to update the data value prior to the E-CSCF node 120 before that emergency communication is forwarded to the PSAP device 208.

Regardless of whether the emergency communication is determined to be directed toward an automated testing process, the E-CSCF node 120 is configured to forward that communication to an appropriate PSAP device 208. In embodiments, the E-CSCF node 120 may identify an appropriate PSAP system to which the emergency communication is to be routed based on a current location of the UE 108. More particularly, the E-CSCF node 120 is configured to identify a PSAP system that is geographically situated to provide emergency services to the UE 108.

In some embodiments, at least a portion of the EENL data 214 may be provided to the UE 108 in order to extend a list of emergency identifiers currently stored by the UE 108. For example, the UE 108 may receive an update that includes an indication that MSISDN “765” is now an emergency identifier that is associated with automated testing processes. In such cases, any communication that originates from the UE 108 that is directed to the MSISDN “765” may include an indication that the communication is an emergency communication. In some cases, generating such a message may put the UE 108 into an emergency operation mode.

PSAP device 208 may be a computing device implemented within a PSAP system (e.g., PSAP system 122 as described in relation to FIG. 1) in order to route emergency communications to an appropriate entity. Similar to the E-CSCF node 120, the PSAP device 208 may include one or more hardware processors 216 configured to execute stored instructions. Such processor(s) 216 may comprise one or more processing cores. Further, the PSAP device 208 may include one or more communication interfaces 218 configured to provide communications between the E-CSCF node 120 and other devices, such as a E-CSCF node 120 or another suitable electronic device.

Similar to the E-CSCF node 120, the PSAP device 208 may include computer-readable media 220 that stores various executable components (e.g., software-based components, firmware-based components, etc.). The computer-readable media 220 may store components to implement functionality described herein. It should be appreciated by those skilled in the art that computer-readable storage media may include any available media that provides for the non-transitory storage of data and that can be accessed by the PSAP device 208. In some examples, the operations performed by devices as described herein may be supported by one or more devices similar to PSAP device 208. Stated otherwise, some or all of the operations performed by PSAP device 208 and/or any components included therein, may be performed by one or more computing device operating in a cloud-based arrangement.

The computer-readable media 220 may include portions, or components, that configure the PSAP device 208 to perform various operations described herein. For example, the computer-readable media 220 may include some combination of components configured to implement the described techniques. In embodiments, the computer-readable media 220 of the PSAP device 208 may include one or more modules for routing emergency communications to an appropriate entity (e.g., communication routing module 222).

A communication routing module 222 may be configured to, upon execution by the processor 216 route emergency communications to an appropriate entity. More particularly, the communication routing module 222 may be configured to initially determine whether the emergency communication is directed toward an automated testing process. If a determination is made that the emergency communication is directed toward an automated testing process, then the emergency communication is routed to a test system implemented within the PSAP system. If a determination is made that the emergency communication is not directed toward an automated testing process, then the emergency communication is routed to an operator, which may be one of multiple operators, based on operator availability.

During operation, a user of a UE 108 may, in order to initiate an automated testing process, generate a communication (e.g., a text message) to be directed to a test system within a PSAP system. The text message may be a Short Message Service (SMS) message, a Multimedia Message Service (MMS) message, a Rich Communication Services (RCS message), or some other type of message. Such a message is directed toward an identifier that corresponds to the automated testing process. The UE transmits that message to an IMS core 202, which then determines that the message is an emergency communication and relays the message to an E-CSCF node 120.

Upon receiving the message, the E-CSCF node 120 identifies the PSAP device 208 based on being located geographically proximate to the UE 108. The E-CSCF node 120 may determine that the message relates to the automated testing process based on a correlation between an identifier included in the message and the automated testing process. Upon making that determination, the E-CSCF node 120 updates a data field of the message to include a label indicating that the message is directed to the automated testing process. The E-CSCF node 120 then forwards the message to the PSAP device 208.

Upon receiving the message, the PSAP device 208 determines that the message is an automated testing message based on the label indicating that the message is directed to the automated testing process. Upon making that determination, the PSAP device 208 routes the message directly to the test system, bypassing the operators of the PSAP system.

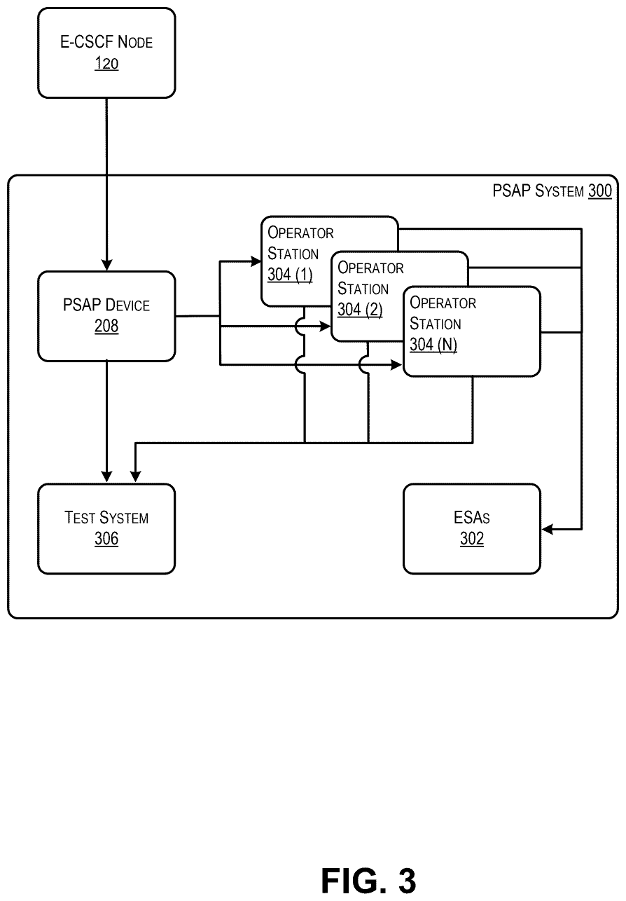

FIG. 3 depicts a block diagram illustrating interactions between various components that may be implemented in a PSAP system 300 in accordance with at least some embodiments. In some cases, a PSAP system 300 is configured to service UEs that are located geographically proximate to itself. In other cases, the PSAP system 300 is configured to connect UEs to Emergency Service Agencies (ESAs) 302 that are located geographically proximate to the UE regardless of a geographic location of physical components of the PSAP system 300.

As depicted, the PSAP system 300 may include a PSAP device 208 that is configured to receive communications from one or more E-CSCF node 120 and to route those communications to other entities within the PSAP system 300. In embodiments, the PSAP device 208 is an example of PSAP device 208 described in relation to FIG. 2. In embodiments, the routing performed by the PSAP device 208 is performed via a communication routing module (e.g., communication routing module 222) implemented on the PSAP device.

Additionally, the PSAP system 300 may include a number of operator stations 304 (e.g., 304 (1−N)) which are staffed by operators. The operator station 304 is operated by a user (e.g., an operator) that is able to receive and assess the received communication. In embodiments, the PSAP device 208 is configured to route the message to an operator station 304 that is not currently processing another communication.

The operator is then able to determine an appropriate ESA 302 to which the communication is to be directed. To do this, the operator may assess one or more data values associated with the communication. In some embodiments, an operator may speak directly with a user of a UE from which the communication originated. In some cases, the operator station 304 may forward the communication to the determined ESA 302. In other cases, the operator station 304 may generate a separate message (e.g., a dispatch message) to be routed to the appropriate ESA 302.

When the PSAP device 208 receives a communication, if that communication includes an indication that the communication is directed toward an automated testing process (e.g., a service field is populated with “Automated Test”), then the PSAP device 208 routes that communication to a test system 306. If the communication does not include an indication that the communication is directed toward an automated testing process, then the PSAP device 208 routes that communication to an operator station 304 of the PSAP system 300.

In some cases, the PSAP device 208 may receive a communication that is directed to the automated testing process but is not labeled. In such cases, the PSAP device 208 may forward the communication to an operator station 304 and that operator station 304 may then forward the communication to the test system 306.

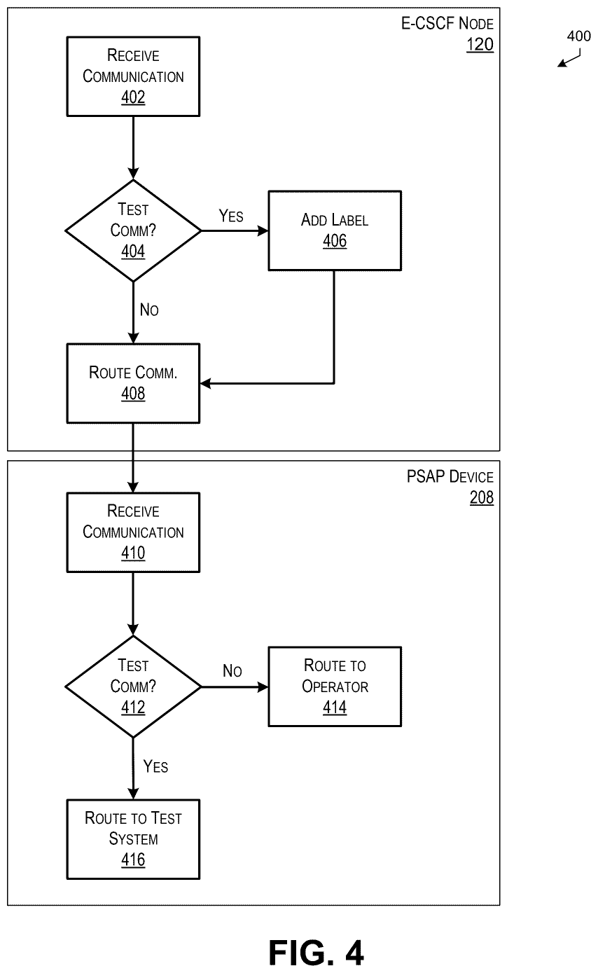

FIG. 4 depicts a flow chart illustrating an exemplary process for labeling and routing emergency communications in accordance with embodiments. The process 400 is depicted as being performed across an E-CSCF node 120 and a PSAP device 208. A first set of steps of process 400 are performed by the E-CSCF node 120 and a second set of steps of process 400 are performed by the PSAP device 208.

At 402, the E-CSCF node 120 may receive an emergency communication. As noted elsewhere, the communication may be received by the E-CSCF node 120 from a P-CSCF node (e.g., P-CSCF node 114 of FIG. 1).

At 404, the E-CSCF node 120 may make a determination as to whether a received communication is directed toward an automated testing process. If the communication is determined not to be directed toward an automated testing process (e.g., “No” at this step), then the process may move on to 408.

As noted elsewhere, a determination as to whether a received communication is directed toward an automated testing process may be made based on whether an identifier included in that communication is included within a list of identifiers stored in relation to emergency services. For example, such a list may include an identifier (or a set of identifiers) that indicate testing communications. In this example, the communication is determined to be directed to an automated testing process if it includes an identifier that matches one in the list that indicate testing communications.

Upon making a determination that the received communication is an emergency communication (e.g., “Yes” at 404), the E-CSCF node 120 may be configured to apply a label to that communication at 406. In some embodiments, this may involve updating a data value within a data field of the communication. For example, the E-CSCF node 120 may be configured to update the service field to include a value such as “Automated Test.”

At 408, the E-CSCF node 120 may identify the PSAP device 208 to which the communication is to be routed. As noted elsewhere, the PSAP device 208 may be identified at least in part based on a geographic location of the PSAP device 208 in relation to a location of a UE from which the communication originated. Once the PSAP device 208 had been identified, the E-CSCF node 120 routes the communication (either with or without a label) to the PSAP device 208.

At 410, the PSAP device 208 receives the communication from the E-CSCF node 120. In some cases, the E-CSCF node 120 may reformat the communication before it is sent to the PSAP device 208. For example, the E-CSCF node 120 may be configured to reformat the communication from being formatted as a SIP request message into a format that can be consumed by the PSAP device 208.

At 412, the PSAP device 208 may make a determination as to whether the received communication is a testing communication. In embodiments, this may involve determining whether the communication includes a label as applied to the communication by the E-CSCF node 120 at 406.

Upon making a determination that the received communication is not a testing communication (e.g., “No” at 404), the PSAP device 208 may be configured to route that communication to an operator at 414.

Upon making a determination that the received communication is a testing communication (e.g., “Yes” at 404), the PSAP device 208 may be configured to route that communication to a test system at 416, bypassing the operators. Upon being received at the test system, the communication may be processed according to an automated testing process.

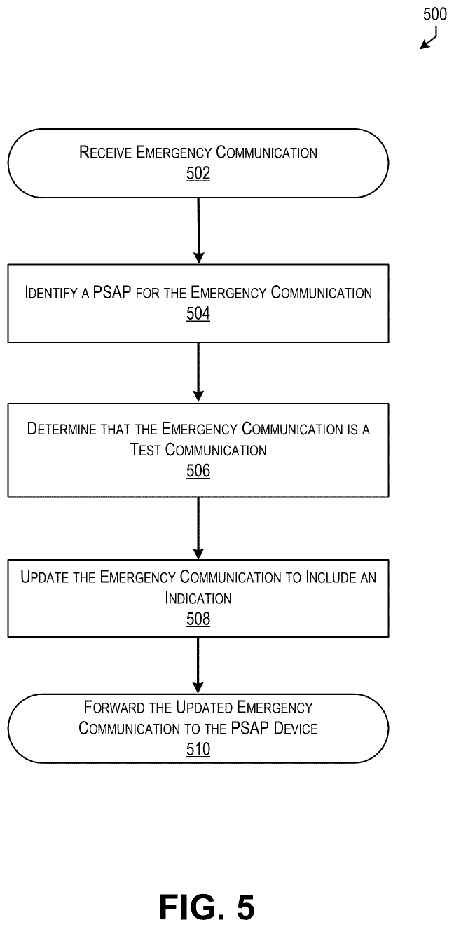

FIG. 5 depicts a flow diagram illustrating an exemplary process for labeling and routing emergency communications directed to a testing process in accordance with at least some embodiments. In embodiments, the process 500 as depicted in FIG. 5 may be performed by an E-CSCF node operating in a network.

At 502, the process 500 may involve receiving an emergency communication at an E-CSCF node. As noted elsewhere, the emergency communication may be formatted as a SIP request and may be received over an IMS core from a P-CSCF node assigned to a UE from which the emergency communication has originated.

At 504, the process 500 may involve identifying a PSAP device to which the emergency communication should be routed. In embodiments, such a PSAP device may be identified based on a geographic proximity of the PSAP device to the UE from which the emergency communication has originated.

At 506, the process 500 may involve determining the emergency communication is a test communication. In some embodiments, the emergency communication is determined to be the test communication based at least in part on a receiving identifier included in the emergency communication. In these embodiments, the receiving identifier may be an identifier for an entity that is to receive the communication. By way of example, the receiving identifier may be a Mobile Station Integrated Services Digital Network (MSISDN) identifier that identifies an entity that the communication is directed to. In this example, the MSISDN identifier may be included in an Extended Emergency Number List (EENL).

At 508, the process 500 may involve updating the emergency communication to include an indication that the emergency communication is a test communication. In some embodiments, the indication that the emergency communication is a test communication is a data field populated with a data value. For example, the data field may be a service field of the emergency communication that is populated with a value such as “Automated Test.” At 510, the process 500 may involve forwarding the updated emergency communication to the PSAP device.

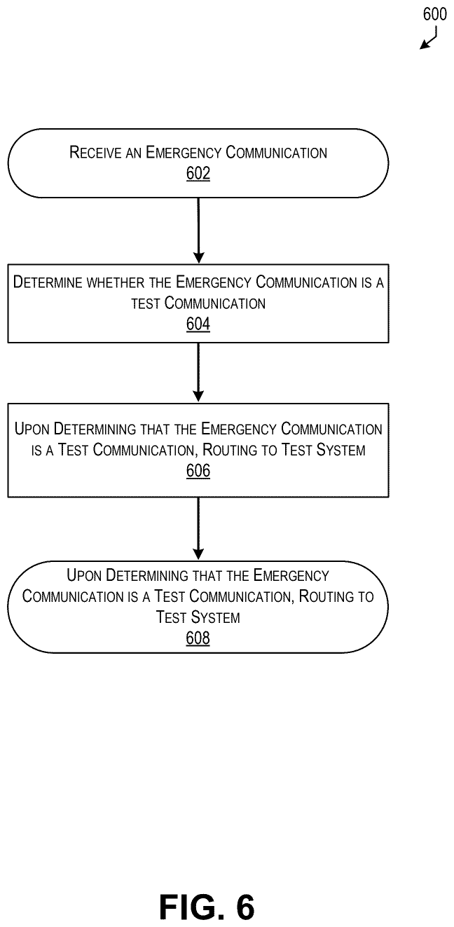

FIG. 6 depicts a flow diagram illustrating an exemplary process for routing emergency communications within a PSAP in accordance with at least some embodiments. In embodiments, the process 600 as depicted in FIG. 6 may be performed by a PSAP device in communication with a network.

At 602, the process 600 may involve receiving an emergency communication at the PSAP device. In embodiments, the emergency communication is received from a E-CSCF node operating in an IMS network.

At 604, the process 600 may involve determining whether the emergency communication is a test communication. In embodiments, the emergency communication is determined to be the test communication based on a data value included in a data field of the emergency communication. For example, a service field of the emergency communication may be populated with a value of “Automated Test,” which indicates a test communication.

At 606, the process 600 may involve, upon determining that the emergency communication is a test communication, routing the emergency communication to a test system. In embodiments, upon making the determination that the emergency communication is a test communication, the emergency communication is routed to the test system absent any interaction with an operator. In other words, the emergency communication is not sent to an operator in such a case.

At 608, the process 600 may involve, upon determining that the emergency communication is not a test communication, routing the emergency communication to an operator station. In some case, this may involve identifying an operator station that is currently in use by an operator and has availability to handle the emergency communication.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
receiving, by a network node from a user equipment (UE), an emergency communication;
identifying, by the network node based on information about the UE, a public service access point (PSAP) device to which the emergency communication is to be routed;
determining, by the network node, that the emergency communication is a test communication;
updating, by the network node, the emergency communication to include an indication that the emergency communication is a test communication; and
forwarding, by the network node, the updated emergency communication to the PSAP device.

2. The method of claim 1, wherein the indication that the emergency communication is a test communication comprises a data field populated with a data value.

3. The method of claim 2, wherein the data field is a service field of the emergency communication.

4. The method of claim 1, wherein the PSAP device is identified based at least in part on a location of the PSAP device.

5. The method of claim 4, wherein the PSAP device is identified if the location of the PSAP device is proximate to a second location of the UE indicated in the information about the UE.

6. The method of claim 1, wherein the emergency communication is determined to be the test communication based at least in part on a receiving identifier included in the emergency communication.

7. The method of claim 6, wherein the receiving identifier comprises a Mobile Station Integrated Services Digital Network (MSISDN) identifier.

8. The method of claim 7, wherein the MSISDN identifier is included in a Extended Emergency Number List (EENL).

9. A network node device comprising:
one or more processors; and
one or more non-transitory computer-readable media storing computer-executable instructions that, when executed by the one or more processors, cause the network node device to perform operations comprising:
receiving, from a user equipment (UE), an emergency communication;
identifying, based on information about the UE, a public service access point (PSAP) device to which the emergency communication is to be routed;
determining that the emergency communication is a test communication;
updating the emergency communication to include an indication that the emergency communication is a test communication; and
forwarding the updated emergency communication to the PSAP device.

10. The network node of claim 9, wherein the indication that the emergency communication is a test communication comprises a data field populated with a data value.

11. The network node of claim 10, wherein the data field is a service field of the emergency communication.

12. The network node of claim 9, wherein the PSAP device is identified based at least in part on a location of the PSAP device.

13. The network node of claim 12, wherein the PSAP device is identified if the location of the PSAP device is proximate to a second location of the UE indicated in the information about the UE.

14. The network node of claim 9, wherein the emergency communication is determined to be the test communication based at least in part on a receiving identifier included in the emergency communication.

15. The network node of claim 14, wherein the receiving identifier comprises a Mobile Station Integrated Services Digital Network (MSISDN) identifier.

16. The network node of claim 15, wherein the MSISDN identifier is included in a Extended Emergency Number List (EENL).

17. A method comprising:
receiving, by a PSAP device, an emergency communication;
determining, by the PSAP device, whether the emergency communication is a test communication;
upon making a determination that the emergency communication is a test communication, routing the emergency communication to a test system; and
upon making a determination that the emergency communication is a test communication, routing the emergency communication to an operator station.

18. The method of claim 17, wherein the emergency communication is determined to be the test communication based on a data value included in a data field of the emergency communication.

19. The method of claim 17, wherein the emergency communication is received from a E-CSCF node operating in an IMS network.

20. The method of claim 17, wherein upon making the determination that the emergency communication is a test communication the emergency communication is routed to the test system absent interaction with an operator.
